(19) United States
(12) Patent Application Publication
(10) Pub. No.: US 2018/0056230 A1
(43) Pub. Date: Mar. 1, 2018

(54) PROCESS AND APPARATUS FOR EFFECTIVE STRIPPING OF PARTLY LADEN SCRUBBING MEDIUM IN PHYSICAL GAS SCRUBBING OPERATIONS

(71) Applicants: Ulvi Kerestecioglu, Geltendorf (DE); Anna-Maria Fischer, Munich (DE)

(72) Inventors: Ulvi Kerestecioglu, Geltendorf (DE); Anna-Maria Fischer, Munich (DE)

(21) Appl. No.: 15/678,271

(22) Filed: Aug. 16, 2017

(30) Foreign Application Priority Data
Aug. 30, 2016 (DE) 10 2016 010 515.1

(51) Int. Cl. B01D 53/14; B01D 53/18

(52) U.S. Cl. CPC B01D 53/1425; B01D 2252/2021; B01D 53/18; B01D 53/1493

(57) ABSTRACT

A process and an apparatus for conducting a gas scrubbing operation are disclosed, in which at least substances of a first type are separated from a gas mixture wherein two or more types of substance by scrubbing with a physical scrubbing medium and a scrubbing medium laden with separated substances of the first type is treated by stripping in order, through the removal of a portion of the substances separated, to obtain a partly regenerated scrubbing medium which is subsequently used again for extractive scrubbing of substances of the first type out of the gas mixture. The characteristic feature is that heat is supplied to the laden scrubbing medium after the commencement and prior to the end of the stripping operation.

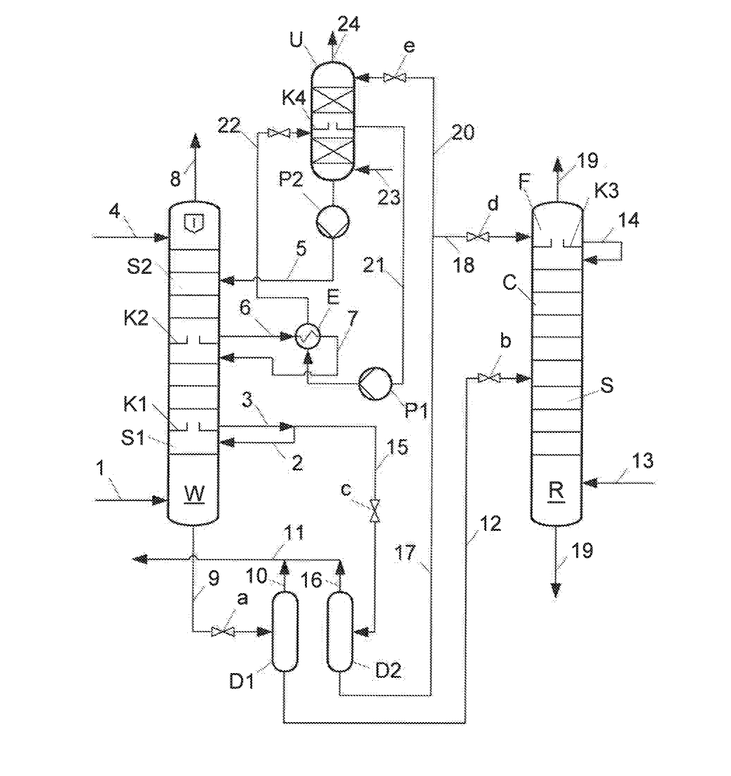

### CROSS REFERENCE TO RELATED APPLICATIONS

This application claims priority from German Patent Application DE 102016010515.1 filed on Aug. 30, 2016.

### BACKGROUND OF THE INVENTION

The invention relates to a process for conducting a gas scrubbing operation, in which at least substances of a first type are separated from a gas mixture comprising two or more types of substance by scrubbing with a physical scrubbing medium and a scrubbing medium laden with separated substances of the first type is treated by stripping in order, through the removal of a portion of the substances separated, to obtain a partly regenerated scrubbing medium which is subsequently used again for extractive scrubbing of substances of the first type out of the gas mixture.

The invention further relates to an apparatus for conducting the process according to the invention.

A process and an apparatus for conducting a gas scrubbing operation in which a partly regenerated scrubbing medium is used for scrubbing of a gas mixture are known, for example, from patent application DE102007051181. They are preferably used to selectively separate sulphur components and carbon dioxide from raw synthesis gases with the aid of cold methanol that serves as scrubbing medium, and to obtain synthesis gases consisting substantially of hydrogen and carbon monoxide.

The sulphur components that dissolve in methanol far better than the carbon dioxide are separated from the raw synthesis gas in a first scrubbing step, using a portion of the methanol that has been laden with carbon dioxide in a second scrubbing step but is free of sulphur as scrubbing medium. The methanol laden with sulphur components and carbon dioxide that has been obtained in the first scrubbing step is expanded and sent to an enrichment column in order to strip out carbon dioxide therein with the aid of a stripping gas and hence to enrich the sulphur components in the methanol.

To minimize sulphur losses, the enrichment column is executed as a scrubbing column in its upper region, in which the sulphur components are rescrubbed out of the laden stripping gas flowing upward. The scrubbing medium used for rescrubbing is obtained from the portion of the methanol that has been laden with carbon dioxide in the second scrubbing step and is not required as scrubbing medium in the first scrubbing step. For this purpose, a partly regenerated methanol scrubbing medium is produced from the carbon dioxide-laden and sulphur-free methanol by separating out a portion of the carbon dioxide. It is standard practice here to separate out the carbon dioxide by flashing, for which the sulphur-free methanol is expanded, for example, into a separator arranged at the top of the enrichment column. The bottom product obtained in the enrichment column—comprising the scrubbed-out sulphur components and a residue of carbon dioxide—is subsequently subjected to further regeneration steps, wherein the dissolved substances are separated out with considerable cost and complexity and fully regenerated methanol scrubbing medium is produced, which is then recycled and used in the second scrubbing step as scrubbing medium for separation of carbon dioxide from the raw synthesis gas.

In order to reduce the amount of methanol to be fully regenerated and hence to increase the economic viability of the gas scrubbing operation, a further partly regenerated methanol scrubbing medium, referred to as “semi-lean”, is produced from the carbon dioxide-laden and sulphur-free methanol by the removal of just a portion of the carbon dioxide, and is then used for scrubbing of carbon dioxide out of the raw synthesis gas without further regeneration in the second scrubbing step.

To obtain the semi-lean with sufficient purity, it may be necessary to separate the carbon dioxide out of the carbon dioxide-laden and sulphur-free methanol by flashing in a first step and by stripping in a second step, with cooling of the methanol down to very low temperatures. Especially in the case of scrubbing of highly converted raw synthesis gas having a high carbon dioxide content, the semi-lean, because of the high carbon dioxide loading of the methanol scrubbing medium, may reach a temperature of less than −75° C. In order that reliable operation of the gas scrubbing operation can be assured, plant components such as pipelines, pumps and column internals with which the cold semi-lean comes into contact have to be constructed from a suitable low-temperature-resistant and therefore costly material, and so the economic advantages achievable through the use of semi-lean are considerably reduced.

The problem addressed by the present invention is that of specifying a process of the type specified at the outset and an apparatus for performance thereof, with which the disadvantages of the prior art can be overcome.

### SUMMARY OF THE INVENTION

The stated object is achieved in accordance with the invention, in terms of the process, in that heat is supplied to the laden scrubbing medium after the commencement and prior to the end of the stripping operation.

Preferably, a sufficient amount of heat is supplied to the laden scrubbing medium that the partly laden scrubbing medium is obtained at a temperature that allows the plant components with which it comes into contact to be manufactured from a non-low-temperature-resistant material without endangering the operational reliability of the gas scrubbing operation. More preferably, the heat is supplied in such a way that the partly laden scrubbing medium is obtained with a temperature of more than −75° C.

According to the invention, the stripping can be effected in such a way that heat is supplied to the laden scrubbing medium, while substances in contact with the stripping gas used are simultaneously removed therefrom. Preferably, however, the stripping is conducted in at least two component steps, wherein the scrubbing medium treated in one component step is separated from the stripping gas used and then warmed, before being contacted with stripping gas again in the subsequent component step. More preferably, the stripping is conducted in exactly two component steps, wherein a stripping gas already preladen with separated substances of the first kind in the second component step can be used in the first component step.

Appropriately, the heat to be supplied to the laden scrubbing medium in the stripping operation can be taken from a process stream obtained within the gas scrubbing operation. This may, for example, be a scrubbing medium stream which is heated up by heat of dissolution released in the scrubbing of the gas mixture. Because of the cooling with the scrubbing medium to be stripped, there is an improvement in the absorption capacity of the scrubbing medium stream for extraneous substances, and for that reason it can be reused advantageously for scrubbing of the gas mixture.

Also particularly suitable for the warming of the partly regenerated scrubbing medium are those process streams which, according to the prior art, are cooled by means of external refrigeration, since external refrigeration can be dispensed with in any case. Moreover, cooling to a lower level than the outside cold level is possible, which under some circumstances gives rise to additional chemical engineering advantages,

Furthermore, the partly regenerated scrubbing medium can be used for operation of a cold trap, with the aid of which, for example, scrubbing medium residues are condensed out of gaseous process streams and removed, such that water scrubbing operations used for this purpose according to the prior art can be dispensed with entirely or at least executed in a smaller size.

For the stripping, preference is given to using nitrogen as stripping gas. However, the use of another gas, for example a purge gas obtained in an absorber station or a flash gas, for this purpose is not to be ruled out.

The process according to the invention is suitable in principle for use in all known gas scrubbing operations. With particular preference, however, it can be used in gas scrubbing operations in which carbon dioxide and sulphur components are scrubbed selectively out of a raw synthesis gas comprising hydrogen, carbon monoxide, carbon dioxide and sulphur components with cryogenic methanol.

The invention further relates to an apparatus for conducting a gas scrubbing operation, comprising an absorber and a stripping unit connected to one another such that a physical scrubbing medium laden with substances of a first type that have been separated from the gas mixture in the scrubbing of the gas mixture in the absorber can be transferred to the stripping unit in order to remove a portion of the substances of the first kind with the aid of a stripping gas and to obtain a partly regenerated scrubbing medium recyclable back to the absorber for extractive scrubbing of substances of the first type from the gas mixture.

The stated problem is solved in accordance with the invention, in terms of the apparatus, in that the stripping unit is connected to a heating unit by means of which heat can be supplied to the laden scrubbing medium after the commencement and prior to the end of the stripping operation.

Preferably, the stripping unit is executed as a column having a feed unit for the laden scrubbing medium in its upper region and a feed unit for a stripping gas in its lower region. The heating unit may be arranged between the two feed units, such that heat can be supplied to the laden scrubbing medium while it is flowing downward in countercurrent to the stripping gas in the column. However, it is also possible for a chimney tray to be mounted between the two feed units, in which case the column is connected to the heating unit such that laden scrubbing medium that has been cooled down in the stripping operation can be drawn off from the chimney tray and, after warming by the heating unit, recycled into the column beneath the chimney tray.

Appropriately, the heating unit is executed as a heat exchanger by means of which heat can be transferred by indirect exchange from a process stream obtained in the gas scrubbing operation to the laden scrubbing medium that has been cooled down in the stripping unit.

More preferably, the heat exchanger, in terms of flow configuration, is connected to the absorber such that a scrubbing medium that has been heated up by heat of dissolution and is used in the absorber can be conducted through the heat exchanger in order to transfer heat to the laden scrubbing medium that has been cooled down in the stripping unit, and then recycled to the absorber in cooled form.

### BRIEF DESCRIPTION OF THE DRAWINGS

The invention is to be more particularly elucidated hereinafter with reference to a working example shown in schematic form in the FIGURE.

The FIGURE shows a methanol scrubbing operation in which a partly regenerated scrubbing medium, in a preferred variant of the invention, is obtained.

### DETAILED DESCRIPTION OF THE INVENTION

Via conduit 1, a raw synthesis gas is introduced into the absorber W executed as a scrubbing column, where two scrubbing sections S1 and S2 are arranged one on top of another, separated from one another by the chimney tray K1. The raw synthesis gas 1 flows upward in the first scrubbing section 51 and, as it does so, is freed of sulphur components in intensive contact with scrubbing medium flowing from the top downward. The scrubbing medium which is fed in via conduit 2 at the upper end of the scrubbing section S1 is a portion of the methanol scrubbing medium which has been laden with carbon dioxide but is free of sulphur components, which is drawn off from the chimney tray K1 via conduit 3. The raw synthesis gas that has been freed of sulphur components subsequently flows via the chimney tray K1 into the second scrubbing section S2 in which it is conducted further upward and, in the process, is washed with scrubbing medium guided in countercurrent and freed of carbon dioxide.

At the top of the scrubbing column W, unladen methanol scrubbing medium 4 and partly carbon dioxide-laden but sulphur-free methanol scrubbing medium 5 are introduced into the second scrubbing section S2. On its way downward, the temperature of the scrubbing medium increases because of the heat of dissolution released in the carbon dioxide absorption, which worsens its dissolution capacity. The scrubbing medium is therefore collected in the chimney tray K2 and fed via conduit 6 to the heat exchanger E, from which it is withdrawn again in cooled form and guided back into the scrubbing column W via conduit 7.

While cleaned synthesis gas 8 is obtained at the top of the scrubbing column W, a scrubbing medium laden with sulphur components and carbon dioxide is drawn off via conduit 9, expanded via the throttle device a and guided into the separator D1, where it is separated into a gas phase and a liquid phase. The gas phase consisting in particular of hydrogen and carbon monoxide co-absorbed in the scrubbing operation is conducted out of the separator D1 via conduit 10 and conducted back into the raw synthesis gas 1 via conduit 11, preferably upstream of the gas scrubbing operation. The liquid phase 12 is expanded further via the throttle device b and introduced into the lower portion of the enrichment column R executed as a stripping column S, in which nitrogen 13 is used as stripping gas.

On its way upward, the stripping gas dissolves predominantly carbon dioxide, but also sulphur components, from the liquid phase flowing downward, such that stripping gas laden with carbon dioxide and sulphur components arrives in the upper portion C of the enrichment column R operated as a scrubbing column. In order to minimize the discharge of sulphur into the environment, the laden stripping gas here is subjected to gas scrubbing, in which the carbon dioxide-preladen but sulphur-free methanol 14 serves as scrubbing medium, which is continuously enriched with rescrubbed sulphur components on its way downward.

To recover the scrubbing medium 14 used in the scrubbing column C, the second portion of the scrubbing medium stream 3 that has been laden with carbon dioxide and is free of sulphur components which is not required as scrubbing medium in the first scrubbing section S1 of the absorber W is conducted onward via conduit 15 and expanded into the separator D2 via the throttle device c. The gas phase formed in the expansion, consisting predominantly of hydrogen and carbon monoxide, is drawn off from the separator D2 via conduit 16 and, just like the gas phase 10, conducted onward via conduit 11. The liquid phase 17 from the separator D2 is divided into two portions, the first of which, 18, is expanded further via the throttle device d to the top of the enrichment column R executed as a separator F. In the expansion, a portion of the carbon dioxide dissolved in the liquid phase 18 is released and subsequently, together with stripping gas in laden form flowing in via the chimney tray K3, conducted out of the gas scrubbing operation as tail gas 19 and released into the environment, while the liquid phase, the carbon dioxide content of which has been reduced in the expansion, is drawn off as scrubbing medium 14.

The second portion 20 of the liquid phase 17 is expanded to the top of the stripping column U via the throttle device e and, for removal of carbon dioxide, contacted at low pressure with a stripping gas which, already having been preladen with carbon dioxide, flows in via the chimney tray K4. In the stripping, carbon dioxide is driven out of the laden scrubbing medium 20 which is cooled down in the process. In order to prevent excessive cooling, the scrubbing medium is drawn off from the chimney tray K4 and fed via conduit 21 and the pump P1 to the heat exchanger E, whence, after being warmed with the scrubbing medium stream 6, it is recycled via conduit 22 and introduced into the stripping column U beneath the chimney tray K4. Here, with the aid of the stripping gas 23, which is preferably nitrogen, there is substantial but incomplete removal of carbon dioxide, wherein the stripping gas is preladen with carbon dioxide and the scrubbing medium is cooled down again, such that partly regenerated scrubbing medium 5, with the aid of the pump P2, can be fed as “semi-lean” to the scrubbing column W for separation of carbon dioxide. The intermediate heating of the laden scrubbing medium 23 in the heat exchanger E ensures that the semi-lean is cold and therefore has good dissolution capacity, but at the same time the plant components that come into contact with it can be manufactured inexpensively from non-low-temperature-resistant materials. The carbon dioxide separated from the scrubbing medium 20 in the stripping is released into the environment as tail gas 24 together with stripping gas.

What we claim is:

1. A process for conducting a gas scrubbing operation, in which at least substances of a first type are separated from a gas mixture comprising two or more types of substance by scrubbing with a physical scrubbing medium and a scrubbing medium laden with separated substances of the first type is treated by stripping in order, through the removal of a portion of the substances separated, to obtain a partly regenerated scrubbing medium which is subsequently used again for extractive scrubbing of substances of the first type out of the gas mixture, characterized in that heat is supplied to the laden scrubbing medium after the commencement and prior to the end of the stripping operation.

2. The process according to claim 1, characterized in that heat obtained in the gas scrubbing operation is supplied to the laden scrubbing medium.

3. The process according to claim 2, characterized in that heat obtained as heat of dissolution in the scrubbing of the gas mixture is supplied to the laden scrubbing medium.

4. The process according to claim 1, characterized in that the stripping is conducted in at least two component steps, with supply of heat to the scrubbing medium obtained in one component step prior to treatment thereof in the subsequent component step.

5. The process according to claim 1, characterized in that methanol is used as the scrubbing medium in order to separate carbon dioxide from a raw synthesis gas.

6. An apparatus for conducting a gas scrubbing operation, comprising an absorber and a stripping unit connected to one another such that a physical scrubbing medium laden with substances of a first type that have been separated from the gas mixture in the scrubbing of the gas mixture in the absorber can be transferred to the stripping unit in order to remove a portion of the substances of the first kind with the aid of a stripping gas and to obtain a partly regenerated scrubbing medium recyclable back to the absorber for extractive scrubbing of substances of the first type from the gas mixture, characterized in that the stripping unit is connected to a heating unit by means of which heat can be supplied to the laden scrubbing medium after the commencement and prior to the end of the stripping operation.

7. The apparatus according to claim 6, characterized in that the stripping unit is executed as a column having, in its upper region, a feed unit for the laden scrubbing medium and, in its lower region, a feed unit for a stripping gas, and a chimney tray arranged between these feed units, with connection of the column to a heat exchanger in such a way that laden scrubbing medium can be drawn off from the chimney tray and, after warming in the heat exchanger, recycled into the column beneath the chimney tray.

8. The apparatus according to claim 7, characterized in that a stream of matter obtained in the gas scrubbing can be cooled by means of the heat exchanger.

9. The apparatus according to claim 8, characterized in that the heat exchanger is connected to the absorber in such a way that heat can be withdrawn from a scrubbing medium used in the absorber.
